(19) United States
(12) Patent Application Publication
(10) Pub. No.: US 2026/0319872 A1
(43) Pub. Date: Oct. 15, 2026

(54) METHOD AND DEVICE WITH DEFECT DETECTION

(71) Applicant: Samsung Electronics Co., Ltd., Suwon-si (KR)

(72) Inventors: Byungjai KIM, Suwon-si (KR); Wissam BADDAR, Suwon-si (KR); Sungjoo SUH, Suwon-si (KR); Saehyun AHN, Suwon-si (KR); Seungju HAN, Suwon-si (KR)

(73) Assignee: Samsung Electronics Co., Ltd., Suwon-si (KR)

(21) Appl. No.: 19/464,856

(22) Filed: Jan. 30, 2026

(30) Foreign Application Priority Data
Feb. 14, 2025 (KR) 10-2025-0019676

(51) Int. Cl. G06F 11/07

(52) U.S. Cl. CPC G06F 11/0754; G06F 11/0715

(57) ABSTRACT

A processor-implemented method including identifying respective first scores related to a defectiveness degree of a plurality of points of a target object; generating a second score indicating a defectiveness degree of a first point of the plurality of points by using a first artificial intelligence (AI) model to classify whether a defect is present based on the respective first scores corresponding to one or more second points of the plurality of points, the one or more second points being within in a predetermined distance of the first point, and a segmented image of the first point; and determining a presence of a defect in the target object based on respective second scores corresponding to the plurality of points.

### CROSS-REFERENCE TO RELATED APPLICATIONS

This application claims the benefit of Korean Patent Application No. 10-2025-0019676, filed on Feb. 14, 2025, in the Korean Intellectual Property Office, the disclosure of which is incorporated herein by reference in its entirety.

### BACKGROUND

### 1. Field of the Invention

The following description relates to an electronic device and a method with defect detection.

### 2. Description of the Related Art

In order to detect a defect occurring in a manufacturing process for a product, various defect detection methods may be used. In particular, an image-based defect detecting method may be applied to a production process of a product in various industrial environments, and each of the production process of the product may be monitored in real time.

### SUMMARY

In a general aspect, here is provided a processor-implemented method including identifying respective first scores related to a defectiveness degree of a plurality of points of a target object; generating a second score indicating a defectiveness degree of a first point of the plurality of points by using a first artificial intelligence (AI) model to classify whether a defect is present based on the respective first scores corresponding to one or more second points of the plurality of points, the one or more second points being within in a predetermined distance of the first point, and a segmented image of the first point; and determining a presence of a defect in the target object based on respective second scores corresponding to the plurality of points..

The one or more second points may be within an area within the predetermined distance includes respective set values for one or more directions from the first point.

The set values may be determined based on a first score corresponding to the first point.

The set value may be determined based on sizes of a plurality of unit elements included in the target object.

The first score corresponding to the first point may include a defect estimated score indicating a defectiveness degree at the first point by using a second AI model to classify whether the defect is present based on the segmented image.

The first score corresponding to the first point may include a value corresponding to a characteristic related to a defect used in determining the defect estimated score.

The generating of the second score may include obtaining a differential image based on a reference image corresponding to the first point and the segmented image; and obtaining an enhanced image in which a defective area is emphasized from the differential image.

Input data of the first AI model may comprise the enhanced image.

The reference image may be determined based on a segmented image corresponding to the first point at a plurality of target objects.

The generating of the second score may include generating a heatmap image indicating a defectiveness degree of the one or more second points based on the respective first scores corresponding to the one or more second points and the heatmap image may be input to the first AI model.

The generating of the second score may include generating a heatmap image indicating a defectiveness degree of the one or more second points based on the respective first scores corresponding to the one or more second points. The heatmap image may be input to the first AI model.

The determining the presence of the defect may include determining the presence of the defect based on comparison between the second score corresponding to a single point of the plurality of points and a reference value.

Each of the plurality of points may correspond to a single area among a plurality of areas according to a division of an image of the target object and the segmented image may be an image of an area corresponding to the first point in the image of the target object.

Each of the plurality of areas may correspond to a single die of a plurality of dies included in a wafer that is the target object.

The plurality of points may be determined to match a predetermined area of the target object by at least a set ratio.

The generating of the second score may include generating a third score to indicate a defectiveness degree at the first point, with respect to one or more of the plurality of points, by using the first AI model based on the respective second scores

corresponding to the one or more second points and the segmented image. The determining the presence of the defect may include determining the presence of the defect based on the third score corresponding to one or more of the plurality of points.

The processor-implemented method may include generating a first image indicating the respective first scores for the plurality of points and a second image indicating the respective second scores for the plurality of points.

In a general aspect, here is provided an electronic device including a memory configured to store one or more instructions, a first processor configured to identify respective first scores related to a defectiveness degree of a plurality of points of a target object, and a second processor configured to generate a second score indicating a defectiveness degree of a first point of the plurality of points by using a first AI model to classify whether a defect is present based on the respective first scores corresponding to one or more second points of the plurality of points, the one or more second points being within in a predetermined distance of the first point, and a segmented image of the first point. Whether the defect is present is determined based on respective second scores corresponding to one or more of the plurality of points .

In a general aspect, here is provided a processor-implemented method including generating a score indicating a defectiveness degree at a first point from among a plurality of points of a target object by using a first AI model to classify whether a defect is present based on data indicating a defectiveness degree of an area within a predetermined distance of the first point, and an image of an area of the target object corresponding to the first point and determining a presence of a defect in the target object based on the generated score.

The determining the presence of the defect may be based on the respective generated scores corresponding to one or more of the plurality of points.

### BRIEF DESCRIPTION OF THE FIGURES

FIG. 1 illustrates an example electronic device according to one or more embodiments.

FIG. 2 illustrates an example with defect detection according one or more embodiments.

FIG. 3 illustrates an example segmented image and reference image at a particular point according to one or more embodiments.

FIG. 4 illustrates an example process of generating a first score and a second score according to one or more embodiments.

FIG. 5 illustrates an example method of generating a second score according to one or more embodiments.

FIG. 6 illustrates an example method with image data pre-processing according to one or more embodiments.

FIG. 7 illustrates an example first image and second image according to one or more embodiments.

FIG. 8 illustrates an example with defect detection according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term "may" herein with respect to an example or embodiment (e.g., as to what an example or embodiment may include or implement) means that at least one example or embodiment exists where such a feature is included or implemented, while all examples are not limited thereto. The use of the terms "example", "embodiment", and "example embodiment" herein have a same meaning (e.g., the phrasing 'in an or one example' has a same meaning as 'in an or one embodiment" and 'in an or one example embodiment'), and "one or more examples" has a same meaning as "one or more embodiments" and "one or more example embodiments". Still further, each of multiple or all separately described an/one "example", "embodiment", "example embodiment", as well as "examples", "embodiments", "example embodiments", herein may be included, in combination, in a same embodiment in any combination.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

In an example, a target object may be an object which is a target of a defect detection method. Because the defect detection method is applicable any time before, after, and during a production process of a product, the target object may correspond to one of an element, a part, and a finished product. The target object may include a plurality of unit elements, and an image filming the target object may be segmented into a plurality of areas. Here, the plurality of areas and the plurality of unit elements may correspond to each other one by one. For instance, in a case that the defect detection method is applied to a semiconductor process, the target object may be a wafer, and the plurality of unit elements may be a plurality of dies. Here, each of a plurality of areas into which an image filming the wafer is segmented may correspond to one of the plurality of dies. Nevertheless, the wafer is merely one example of the target object, and the scope of the present invention is not limited thereto.

In order to quickly determine whether a defect of the target object is present, an electronic device may measure a defectiveness degree with respect to only a partial area among the plurality of areas, and may not measure a defectiveness degree with respect to remaining areas. That is, the electronic device may not measure the areas outside the partial area. In an example, each of a plurality of points may correspond to an area which is arbitrarily determined from among the plurality of areas. More specifically, in case that a relatively large number of defects are usually identified at a particular area of the target object (i.e., known locations where defects typically occur), the plurality of points may be determined to match the particular area of the target object by a set ratio or higher.

In an example, a segmented image of a first point may be an image of an area corresponding to the first point in an entire image of a target object. That is, in a process of identifying defects, the first point is a location currently being considered. Further, a reference image of the first point is an image compared to the segmented image in order to determine whether a defect is present at the first point, and may be an image of the area corresponding to the first point in a case where a defect is not present in a reference object being considered. Image data, in which the segmented image and the reference image are pre-processed, may be used as input data for a first AI model and a second AI model which are classification models to determine whether a defect is present.

In an example, the second AI model may be an AI model for classifying whether a defect is present at each of a plurality of points based on a segmented image. The second AI model is a neural network specialized in processing image data, and may be ResNet and a vision transformer, without being limited thereto. The data that may be input to the second AI model may include image data in which a segmented image at each of the plurality of points is pre-processed. The data generated by the second AI model may output a defect estimated score indicating a defectiveness degree of each of the plurality of points.

In an example, a first score may include a score related to the defectiveness degree of each of a plurality of points. As an example, the first score at each of the plurality of points may include the defect estimated score that indicates the defectiveness degree of each of the plurality of points, without being limited thereto. As another example, the first score at each of the plurality of points may include a value corresponding to a characteristic related to a defect used in determination of the defect estimated score. For instance, the characteristic related to the defect may be a characteristic related to a defect such as an existence of a defect area, a size of a defect area, a degree of a defect (for instance, a brightness of a defect area) and the like, without being limited thereto.

In an example, the first AI model is an AI model for classifying whether a defect is present at each of a plurality of points based on a segmented image and a first score, and may be a multi-modal classification model. When it is determined whether a defect is present at the first point, the data input to the first AI model may include image data in which a segmented image at the first point is pre-processed, and score data in which the first score corresponding to each of at least one second point included in a nearby area of the first point is pre-processed (i.e., the second points may be proximate to the first point being considered). Further, the first AI model may generate output data including a defect estimated score indicating a defectiveness degree of the first point. Further, a second score may be a defect estimated score indicating the defectiveness degree of each of the plurality of points, and the first AI model may generate the second score.

Hereinafter, examples of the present invention will be described in detail with reference to the accompanying drawings so that those of ordinary skill in the art to which the present invention pertains may easily implement them. However, the present invention may be implemented in multiple different forms and is not limited to the example embodiments described herein.

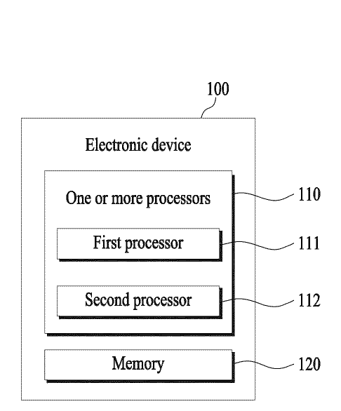

FIG. 1 illustrates an example electronic device according to one or more embodiments.

Referring to FIG. 1, in a non-limiting example, an electronic device 100 may include one or more processors 110 and a memory 120. With respect to the electronic device 100 which is illustrated in FIG. 1, some elements associated with the present example embodiment are illustrated. However, those skilled in the art associated with the present example may understand that other elements may be included in addition to the elements illustrated in FIG. 1.

The one or more processors 110 may control overall operations of the electronic device 100. The one or more processors 110 may be composed of at least one hardware unit. In addition, the one or more processors 110 may be operated by one or more software modules generated by executing one or more instructions stored in the memory 120. The one or more processors 110 may control example embodiments performed by the electronic device 100 through interaction with the memory 120 and elements that may be further included in the electronic device 100.

For example, the one or more processors 110 may include a first processor 111 and a second processor 112. Here, the processor 110 may be, for example, a general-purpose processor such as a central processing unit (CPU), an application processor (AP), and a digital signal processor (DSP), a graphics-only processor such as a graphic processing unit (GPU) and a vision processing unit (VPU), or an AI-only processor such as a neural processing unit (NPU), and may be other various processors. For instance, the first processor 111 may be a CPU, and the second processor 112 may be a GPU, without being limited thereto. Each operation of the defect detection method may be performed by one processor between the first processor 111 and the second processor 112 which may be physically separated. On the other hand, a single processor that performs the operations for both the first processor 111 and the second processor 112 may also be within the scope of the present invention, and in this case, an operation of the defect detection method may be performed by that one processor.

In an example, the first processor 111 may identify or generate a first score related to a defectiveness degree of each of a plurality of points of a target object. More specifically, the first processor 111 may perform an operation of identifying the first score related to the defectiveness degree of each of the plurality of points of the target object and an image at each of the plurality of points. Here, data with respect to the image may include a segmented image and a reference image at each of the plurality of points.

Alternatively, the second processor 112 may, with respect to each of the plurality of points, use the first AI model to classify whether a defect is present based on the first score corresponding to each of the at least one second point included in the nearby area of the first point and the segmented image of the first point, generate a second score indicating the defectiveness degree of the first point. The second processor 112 may perform an operation of pre-processing the first score corresponding to each of the at least one second point, and may perform an operation of pre-processing the segmented image and the reference image of the first point. The image data in which the segmented image is pre-processed and the score data in which the first score is pre-processed may be used as the input data of the first AI model. Further, the second processor 112 may use the first AI model stored in the memory 120 having the pre-processed image data and the pre-processed score data as the input data, so as to perform an operation of generating the second score indicating the defectiveness degree of the first point.

Here, whether a defect of the target object is present may be determined based on the second score corresponding to each of the plurality of points. More specifically, the determination of whether a defect of the target object is present may be determined based on a comparison between the second score and a reference value corresponding to single point of the plurality of points,. As an example, in a case where the second score corresponding to one point of the plurality of points is greater than the reference value, it may be determined that a defect is present at the target object. As another example, in a case where the second score corresponding to each of the plurality of points is smaller than the reference value, it may be determined that a defect is not present at the target object.

The memory 120 may include computer-readable instructions. The one or more processors 110 may be configured to execute computer-readable instructions, such as those stored in the memory 120, and through execution of the computer-readable instructions, the one or more processors 110 may be configured to perform one or more, or any combination, of the operations and/or methods described herein. The memory 120 may be referred to as a storage and may be a volatile memory or a non-volatile memory. The memory 120 may store various kinds of information for performing the defect detection method. For instance, stored in the memory 120 are the first AI model, the second AI model, a first score at each of a plurality of points, a segmented image at each of a plurality of points, a reference image at each of a plurality of points, and a second score at each of a plurality of points.

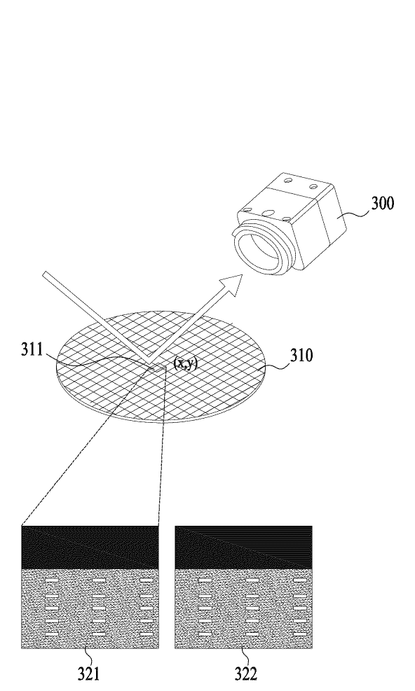

Although not illustrated in FIG. 1, the electronic device 100 may further include a camera sensor (e.g., camera device 300 of FIG. 3) for filming a target object. The electronic device 100 may obtain a segmented image of each of the plurality of points from an image of the target object, filmed by means of the camera sensor, and may perform operations to determine whether a defect of the target object is present. Nevertheless, the electronic device 100 does not necessarily include the camera sensor, and the image of the target object may be obtained by being filmed from an external camera device. Here, the image of the target object, which is obtained by means of the external camera device, may be stored in the memory 120 of the electronic device 100.

In an example, the electronic device 100 may further include a transceiver (not illustrated). The transceiver is an apparatus for performing wired/wireless communication, and may communicate with an external electronic device. Here, the external electronic device may be the external camera device, without being limited thereto. A communication technology used by the transceiver may include global system for mobile communication (GSM), code division multi access (CDMA), long term evolution (LTE), 5th Generation, (5G), a wireless local area network (WLAN), Wireless-Fidelity (Wi-Fi), Bluetooth, radio frequency identification (RFID), infrared data association (IrDA), ZigBee, near field communication (NFC), or the like.

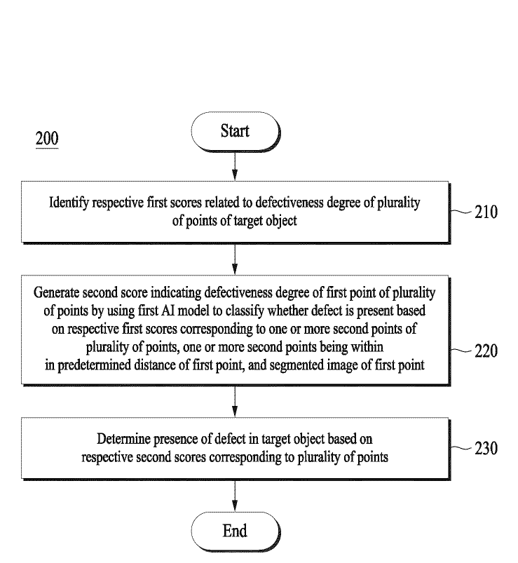

FIG. 2 illustrates an example with defect detection according one or more embodiments.

Referring to FIG. 2, in a non-limiting example, it may be clearly understood that each operation of a defect detection method 200 which may be performed by an electronic device (e.g., electronic device 100) may be partially changed, substituted, or some of the order between operations may be changed within a scope clearly understandable to a person having ordinary skill in the art to which the example embodiments disclosed in this specification pertain.

In an example, in operation 210, the electronic device (e.g., electronic device 100) may identify respective first scores related to a defectiveness degree of a plurality of points of a target object. The first score may include a defect estimated score generated from the second AI model for classifying whether a defect is present at each of the plurality of points based on a segmented image, without being limited thereto. As described above, the first score may include a value corresponding to a characteristic related to a defect used in determination of the defect estimated score.

In addition, the electronic device may identify image data at of a plurality of points along with a first score. Thus, a respective first score may be obtained at one or more of the plurality of points. Here, the image data may include a segmented image and a reference image at each of a plurality of points. For example, the respective first scores may be found for each of the plurality of points.

In an example, in operation 220, the electronic device (e.g., electronic device 100) may generate a second score indicating a defectiveness degree of a first point of the plurality of points by using a first AI model to classify whether a defect is present based on the respective first scores corresponding to one or more second points of the plurality of points, the one or more second points being within in a predetermined distance of the first point, and a segmented image of the first point.

Here, A nearby area of the first point may correspond to an area within a set value in each of a plurality of directions based on the first point. In a case that the defect detection method 200 is to identify whether a defect is present at a particular surface of a target object, the plurality of directions may include an x direction and a y direction which are orthogonal to each other, without being limited thereto.

Here, the set value may be set to have an identical value at each point without being limited thereto, and the set value may be set to have a value different for each point. Alternatively, the set value may be set to have an identical value for each point.

The set value may be determined based on sizes of a plurality of unit elements constituting the target object. As an example, in a case that a wafer, which is a target object, is segmented into a plurality of dies, the set value may be a first value. As another example, in a case that the wafer, which is the target object, is segmented into a plurality of slices, the set value may be a second value. Here, because it may be adequate that, the smaller the size of the unit elements is, the greater number of unit elements are included in the nearby area, the smaller the size of the unit elements is, the greater the set value may be determined. Because a die is a unit element smaller than a slice, the first value may be set to be greater than the second value.

The set value may be set to have a different value for each point. The set value may be determined based on a first score corresponding to a point. More specifically, as it may be predicted that, the greater the first score corresponding to the point is, the more likely a defect is to be present nearby a point, the set value may be determined to be in proportion to the first score. In other words, the set value corresponding to a point at which the first score is great may be greater than the set value corresponding to a point at which the first score is small.

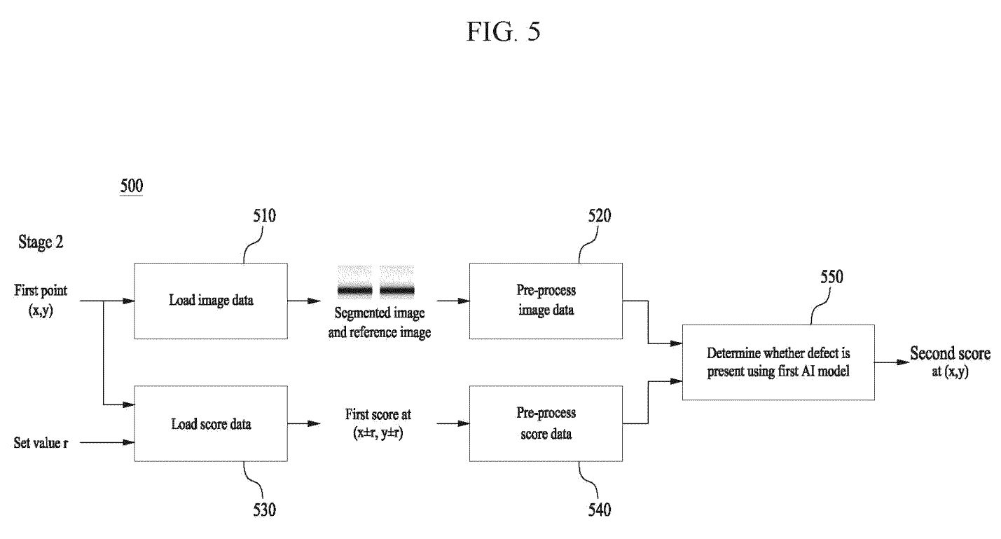

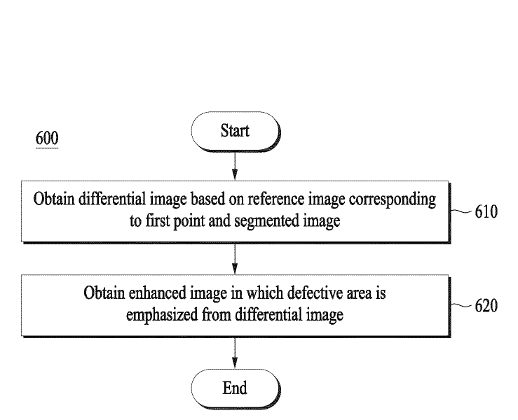

Before the second score is generated, a pre-processing operation to generate the input data of the first AI model may precede. For instance, the electronic device may perform a pre-processing operation with respect to a first score corresponding to each of at least one second point. More specifically, the electronic device may perform the pre-processing operation with respect to the first score corresponding to each of the at least one second point included in the nearby area of the first score at each of the plurality of points identified in operation 210. As described above, since each of the plurality of points is arbitrarily determined to correspond to an area among the plurality of areas, the number of the second point included in the nearby area corresponding to each of the plurality of points may differ. In other words, the pre-processed score data, according to the pre-processing operation being performed, may indicate a defectiveness degree of the nearby area regardless of the number of the second point included in the nearby area. The pre-processing operation with respect to the first score corresponding to each of the at least one second point will be described in greater detail below in FIG. 5. As another example, the electronic device may perform the pre-processing operation with respect to the image data. The operation of pre-processing the image data in order for a defect area to be emphasized based on a segmented image corresponding to a first point and a reference image corresponding to a first point will be described in greater detail below in FIG. 6.

In an example, in operation 230, the electronic device (e.g., electronic device 100) may determine a presence of a defect in the target object based on respective second scores corresponding to the plurality of points. In an example, the electronic device may, based on comparison between the second score and a reference value corresponding to one point of the plurality of points, determine whether a defect of the target object is present. In a case that the second score corresponding to one point of the plurality of points is greater than the reference value, the electronic device may determine that a defect is present at the target object. On the contrary, in a case that the second score corresponding to each of the plurality of points is smaller than the reference value, the electronic device may determine that a defect is not present at the target object.

FIG. 3 illustrates an example segmented image and reference image at a particular point according to one or more embodiments.

Referring to FIG. 3, in a non-limiting example, a camera device 300 may film a target object 310 in real time. Referring to FIG. 1, in an example, the electronic device 100 may include a camera sensor, the electronic device 100 may correspond to the camera device 300, without being limited thereto. In a case that the electronic device 100 does not include the camera sensor, the camera device 300 may be an external camera device distinguished from the electronic device 100, and an image filmed by the camera device 300 may be stored in the memory 120 of the electronic device 100. Referring back to FIG. 3, in an example, the camera device 300 is illustrated as an external camera device.

Here, the camera device 300 may be placed at a production process of the target object 310 before monitoring the target object 310 in real time. The target object 310 may be composed of a plurality of elements, and an image of the target object 310 may be segmented based on a plurality of areas including an area 311.

In relation thereto, a partial image of an area of an image filming the target object 310 may be referred to as a segmented image. For instance, a segmented image 321 may correspond to the area 311 marked with (x, y). Further, a reference image 322 may be an image of a case in which a defect is not present at the area 311.

In a case that a defect is present at the area 311, a difference between the segmented image 321 and the reference image 322 may be identified. Meanwhile, in a case that a defect is not present or a defect is not considerable at the area 311, a difference between the segmented image 321 and the reference image 322 may not be identified.

In an example, a reference image may be obtained from an image of another target object in which it is identified that a defect is not present before being stored in a memory (e.g., memory 120), without being limited thereto. For instance, the reference image may be determined based on a segmented image corresponding to an area at each of a plurality of target objects which are a target of defect detection including the target object 310. Here, the plurality of target objects may be objects at which whether a defect is present is not determined. Even when a defect is present at a random location of some target objects among the plurality of target objects, as a segmented image of the plurality of target objects overlaps, a reference image from which the defect is removed may be obtained.

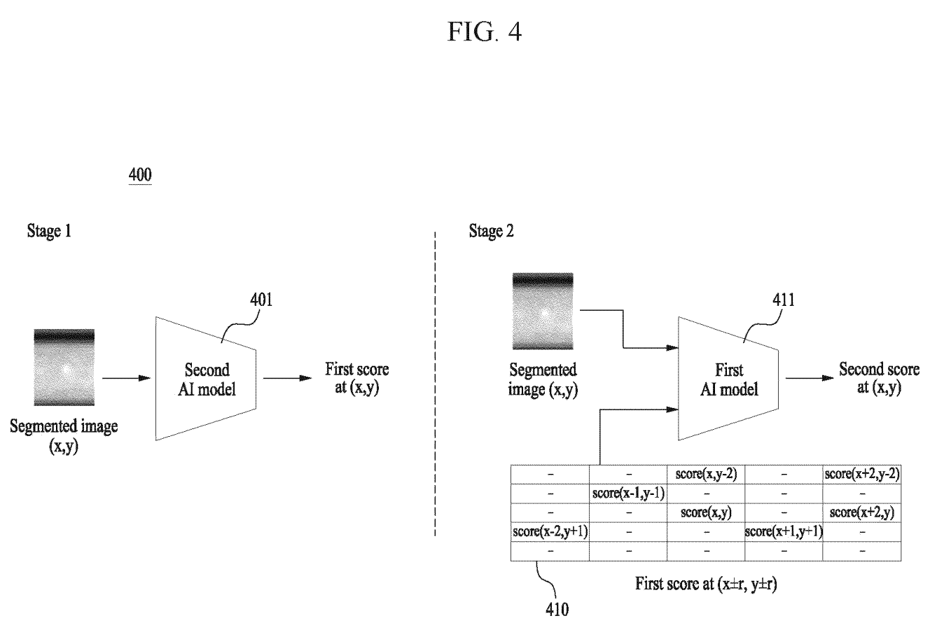

FIG. 4 illustrates an example process of generating a first score and a second score according to one or more embodiments.

Referring to FIG. 4, in a non-limiting example, a defect detection process 400 may be segmented into a stage 1 and a stage 2. The stage 1 may be an operation of generating a first score by using a second AI model 401 based on a segmented image, and the stage 2 may be an operation of generating a second score by using a first AI model 411 based on the segmented image and the first score corresponding to a nearby area. The first AI model 411 used in the stage 2 is a multi-modal classification model, and may be an AI model which is different from the second AI model 401 used in the stage 1.

As the second AI model 401 is used based on the segmented image of a first point corresponding to an area marked with (x, y) in the stage 1, the first score at the first point may be generated. As a similar operation is repeated with respect to each of the plurality of points, the first score at each of the plurality of points may be generated. However, in case that a quality of an image is not high (for instance, in case that an image is in a low resolution or a signal-to-noise ratio thereof is low), performance of the image-based defect detection method by means of the stage 1 which only uses a segmented image may be significantly reduced. In relation thereto, the stage 2 may be an operation of generating the second score further based on, in addition to the segmented image, the first point corresponding to each of at least one second point included in the nearby area. That is, the nearby area may be second points that are points within a predetermined distance to the first point.

In an example, the stage 2 may occur after the first score is generated at each of the plurality of points. As the first AI model 411 is used based on the segmented image of the first point corresponding to the area marked with (x, y) in the stage 2 and the first score corresponding to each of the at least one second point included in the nearby area of the first point, the second score at the first point may be generated. As a similar operation is repeated with respect to each of the plurality of points, the second score at each of the plurality of points may be generated.

Referring to FIG. 4, the nearby area of the first point corresponding to the area marked with (x, y) may be marked with (x±r, y±r). The nearby area of the first point may include an area within r which is a value set in the x direction and the y direction based on the area marked with (x, y). As described above, because each of the plurality of points is arbitrarily determined to correspond to an area among the plurality of areas, there may be a point among the plurality of points, corresponding to only some areas among the plurality of areas, and there may not be corresponding points among the plurality of points for remaining areas. In other words, only a first score corresponding to some areas among the plurality of areas is generated at the stage 1, and a first score corresponding to the remaining areas may not be generated at the stage 1. For instance, in a case that r is 2, only the first score with respect to a point corresponding to an area marked with (x, y-2), (x+2, y-2), (x-1, y-1), (x, y), (x+2, y), (x-2, y+1), (x+1, y+1) in the nearby area is generated, and the first score with respect to a point corresponding to remaining areas in the nearby area may not be generated. As in FIG. 4, a first score corresponding to each of at least one second point included in a nearby area may be displayed as tabular data 410.

However, the defect detection method (e.g., method 200) is not limited to including only the stage 1 for generating the first score and the stage 2 for generating the second score. For instance, the defect detection method may further include an operation of repeatedly performing a separate stage which is similar to the stage 2 by a set number of times. In relation thereto, an electronic device (e.g., electronic device 100) may perform the defect detection method, with respect to each of the plurality of points, by using the first AI model based on the second score and the segmented image corresponding to each of the at least one second point included in the nearby area, generate a third score indicating the defectiveness degree of the first point. After that occurs, the electronic device may, based on the third score corresponding to each of the plurality of points, determine whether a defect of the target object is present. In other words, the second score in the stage 2 may be used as a score which is a pre-processing target of the first AI model in the stage 3. Similarly, a score generated by the first AI model in the previous stage may be used as a score which is a pre-processing target of the first AI model in the following stage. In a case that the corresponding operations are repeatedly performed, depending on at which the plurality of points are located between a defective area and a non-defective area which are included in the target object, the second score at each of the plurality of points may indicate a tendency of being clearly classified based on the reference value. Therefore, the electronic device performing the defect detection method may more precisely determine not only whether a defect of a target object is present but also a location of a defective area included in the target object.

FIG. 5 illustrates an example method of generating a second score according to one or more embodiments.

Referring to FIG. 5, in a non-limiting example, method 500 may include an operation of repeatedly (i.e., iteratively) generating a second score with respect to each of a plurality of points. For example, method 500 may generate a second score at a first point corresponding to an area marked with (x, y) among a plurality of points.

In an example, in operation 510, an electronic device (e.g., the electronic device 100) may perform an image data loading process. In relation thereto, the electronic device may load a segmented image corresponding to a first point and a reference image corresponding to the first point.

In an example, in operation 520, the electronic device (e.g., electronic device 100) may perform an image data pre-processing process. An operation of pre-processing in order for a defective area to be emphasized based on the segmented image corresponding to the first point and the reference image corresponding to the first point will be described in greater detail below in FIG. 6.

In an example, in operation 530, the electronic device (e.g., electronic device) 100 may perform a score data loading process. In relation thereto, the electronic device may generate a first score at the first point corresponding to an area marked with (x, y) and at least one second point included in a nearby area of the first point based on r which is a set value corresponding to the first point. As described above, the electronic device may generate the first score corresponding to each of the at least one second point included in the nearby area marked with (x±r, y±r).

In an example, in operation 540, the electronic device (e.g., electronic device 100) may perform a score data pre-processing process. Here, the score data pre-processing process may be a process of generating pre-processed data to indicate a defectiveness degree of the nearby area of the first point by processing the first score corresponding to the unfixed number of second points. In other words, the score data pre-processing process may be a process of processing the first score corresponding to the various numbers of second points to process the same into a form capable of being used as the input data of the first AI model.

In an example, the electronic device may, based on a first score corresponding to each of at least one second point, generate a heatmap image indicating a defectiveness degree of a nearby area. A process of generating the heatmap image may be referred to as a spatial encoding process or a tabular-to-image translation process. The heatmap image may be an image marking a first score corresponding to each of at least one second point with a color. More specifically, an area corresponding to a point at which a first score is high may be marked with a red color on the heatmap image, and an area corresponding to a point at which the first score is low may be marked with a purple color on the heatmap image. The heatmap image is data in an image form regardless of the number of at least one second point, and may be used as one of the input data of the first AI model.

In an example, the electronic device may, by using a third AI model based on a first score corresponding to each of at least one second point, generate a feature vector indicating a defectiveness degree of a nearby area. The process of generating a feature vector may be a process of performing tabular-to-feature translation by using a neural network. Here, the feature vector generated from the third AI model may be characterized by having a fixed length regardless of the at least one second point. The feature vector of a set length may be used as one of the input data of the first AI model.

In an example, in operation 550, the electronic device (e.g., electronic device 100) may perform a defect existence determination process using the first AI model. The input data of the first AI model, which is a multi-modal classification model for classifying whether a defect is present, may include image data pre-processed in operation 520 and score data pre-processed in operation 540 which are data of forms different from each other. The electronic device may generate the second score indicating a defectiveness degree at the first point (x, y) by using the first AI model having the pre-processed image data and the pre-processed score data as the input data.

FIG. 6 illustrates an example method with image data pre-processing according to one or more embodiments.

Referring to FIG. 6, in a non-limiting example, method 600 may include operations 610 and 620. For example, in operation 610, an electronic device (e.g., electronic device 100) may, based on a segmented image and a reference image, obtain a differential image. The differential image may be an image indicating a difference between the segmented image and the reference image. In a case that a defect is present at a target object, reflectivity at a defective area of the target object may be different from reflectivity at a normal area in a case where a defect is not present. Therefore, when a defect detection method, such as method 600, is performed under a bright field (BF) environment, the defective area included in the target object may be brightly marked on the differential image.

In an example, in operation 620, the electronic device (e.g., electronic device 100) may obtain an enhanced image in which the defective area is emphasized/stressed from the differential image. More specifically, the electronic device may generate the enhanced image by adjusting intensity of the defective area included in the differential image. The enhanced image may be used as one of the pieces of data input to the first AI model. Further, the enhanced image may be data input to the second AI model.

Here, depending on whether the defective area is present or not, a bright area may be present or may not be present in the enhanced image. In a case where the defective area is present, the greater the size of the defective area is, the more greatly the bright area in the enhanced image may be marked. Further, the greater the defectiveness degree is, the more brightly the bright area in the enhanced image may be marked.

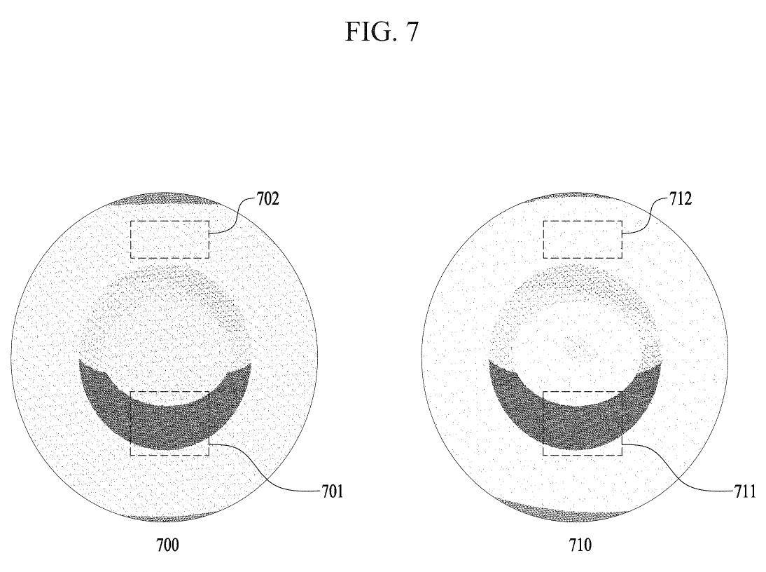

FIG. 7 illustrates an example first image and second image according to one or more embodiments.

Referring to FIG. 7, in a non-limiting example, an electronic device (e.g., the electronic device 100) may generate a first image indicating a first score at each of a plurality of points and a second image indicating a second score at each of the plurality of points. In other words, a first image 700 may indicate the first score generated by means of the stage 1 of FIG. 4, and a second image 710 may indicate the second score generated by means of the stage 1 and the stage 2 of FIG. 4. An area corresponding to a point at which the first score and the second score are great may be marked as a dot of a dark color (i.e., a dark dot) on the first image 700 and the second image 710. On the contrary, an area corresponding to a point at which the first score and the second score are small may be marked as a dot of a white color (i.e., a white dot) on the first image 700 and the second image 710.

In a first area 701 and a second area 702 of the first image 700, multiple lightly colored dots having light colors (i.e., dots having shades of colors that do not include the dark dots and the white dots) may be included. The lightly colored dots may signify an area in which whether a defect is present is unclear. Meanwhile, in a first area 711 and a second area 712 of the second image 710, there may be relatively few the lightly colored dots . In other words, because the stage 2 is further performed in addition to the stage 1, an existence of a defect of a target object and a location of a defective area included in the target object may be more precisely determined.

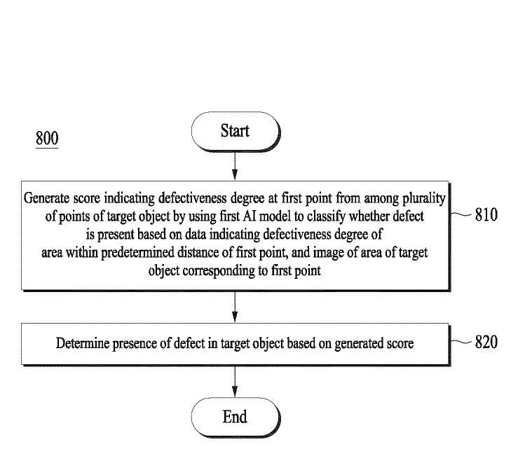

FIG. 8 illustrates an example with defect detection according to one or more embodiments.

Referring to FIG. 8, in a non-limiting example, method 800 may include operations 810 and 820. In an example, in operation 810, an electronic device (e.g., the electronic device 100) may generate a score indicating a defectiveness degree at a first point from among a plurality of points of a target object by using a first AI model to classify whether a defect is present based on data indicating a defectiveness degree of an area within a predetermined distance of the first point, and an image of an area of the target object corresponding to the first point. Here, data indicating a defectiveness degree with respect to a nearby area may correspond to the first score corresponding to each of the at least one second point included in the nearby area of the first point in operation 220. Alternatively, the data indicating the defectiveness degree with respect to the nearby area may be the pre-processed score data according to the score data pre-processing process being performed in operation 540. The score indicating the defectiveness degree of the first point may correspond to the second score in operation 220.

In an example, in operation 820, the electronic device (e.g., electronic device 100) may determine a presence of a defect in the target object based on the generated score. As described above, the electronic device may, based on comparison between the score and a reference value corresponding to one point among the plurality of points, determine whether a defect of the target object is present.

The electronic devices, processors, memories, neural networks, electronic device 100, one or more processors 110, first processor 111, second processor 112, memory 120, and camera sensor 300, described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
identifying respective first scores related to a defectiveness degree of a plurality of points of a target object;
generating a second score indicating a defectiveness degree of a first point of the plurality of points by using a first artificial intelligence (AI) model to classify whether a defect is present based on the respective first scores corresponding to one or more second points of the plurality of points, the one or more second points being within in a predetermined distance of the first point, and a segmented image of the first point; and
determining a presence of a defect in the target object based on respective second scores corresponding to the plurality of points.

2. The method of claim 1, wherein the one or more second points are within an area within the predetermined distance includes respective set values for one or more directions from the first point.

3. The processor-implemented method of claim 2, wherein the set values are determined based on the first score corresponding to the first point.

4. The processor-implemented method of claim 2, wherein the set values are determined based on sizes of a plurality of unit elements included in the target object.

5. The processor-implemented method of claim 1, wherein the first score corresponding to the first point includes a defect estimated score indicating a defectiveness degree at the first point by using a second AI model to classify whether the defect is present based on the segmented image.

6. The processor-implemented method of claim 5, wherein the first score corresponding to the first point includes a value corresponding to a characteristic related to a defect used in determining the defect estimated score.

7. The processor-implemented method of claim 1, wherein the generating of the second score comprises:
obtaining a differential image based on a reference image corresponding to the first point and the segmented image; and
obtaining an enhanced image in which a defective area is emphasized from the differential image.

8. The processor-implemented method of claim 7, wherein input data of the first AI model comprises the enhanced image.

9. The processor-implemented method of claim 7, wherein the reference image is determined based on a segmented image corresponding to the first point at a plurality of target objects.

10. The processor-implemented method of claim 1, wherein the generating of the second score comprises:
generating a heatmap image indicating a defectiveness degree of the one or more second points based on the respective first scores corresponding to the one or more second points, and
wherein the heatmap image is input to the first AI model.

11. The processor-implemented method of claim 1, wherein the generating of the second score comprises generating a feature vector indicating a defectiveness degree of the one or more second points by using a third AI model based on the respective first scores corresponding to the one or more second points, and
wherein the feature vector is set to a set length and is input to the first AI model.

12. The processor-implemented method of claim 1, wherein the determining the presence of the defect comprises:
determining the presence of the defect based on comparison between the second score corresponding to a single point of the plurality of points and a reference value.

13. The processor-implemented method of claim 1, wherein each of the plurality of points corresponds to a single area among a plurality of areas according to a division of an image of the target object, and
wherein the segmented image is an image of an area corresponding to the first point in the image of the target object.

14. The processor-implemented method of claim 13, wherein each of the plurality of areas corresponds to a single die of a plurality of dies included in a wafer that is the target object.

15. The processor-implemented method of claim 13, wherein the plurality of points are determined to match a predetermined area of the target object by at least a set ratio.

16. The processor-implemented method of claim 1, wherein the generating of the second score comprises:
generating a third score to indicate a defectiveness degree at the first point, with respect to one or more of the plurality of points, by using the first AI model based on the respective second scores corresponding to the one or more second points and the segmented image, and
wherein the determining the presence of the defect comprises:
determining the presence of the defect based on the third score corresponding to one or more of the plurality of points.

17. The processor-implemented method of claim 1, further comprising generating a first image indicating the respective first scores for the plurality of points and a second image indicating the respective second scores for the plurality of points.

18. An electronic device, the electronic device comprising:
a memory configured to store one or more instructions;
a first processor configured to identify respective first scores related to a defectiveness degree of a plurality of points of a target object; and
a second processor configured to generate a second score indicating a defectiveness degree of a first point of the plurality of points by using a first AI model to classify whether a defect is present based on the respective first scores corresponding to one or more second points of the plurality of points, the one or more second points being within in a predetermined distance of the first point, and a segmented image of the first point, wherein whether the defect is present is determined based on respective second scores corresponding to one or more of the plurality of points.

19. A processor-implemented method, the method comprising:
generating a score indicating a defectiveness degree at a first point from among a plurality of points of a target object by using a first AI model to classify whether a defect is present based on data indicating a defectiveness degree of an area within a predetermined distance of the first point, and an image of an area of the target object corresponding to the first point; and
determining a presence of a defect in the target object based on the generated score.

20. The method of claim 19, wherein the determining the presence of the defect is based on the respective generated scores corresponding to one or more of the plurality of points.
